(19) United States
(12) Patent Application Publication
(10) Pub. No.: US 2006/0209348 A1
(43) Pub. Date: Sep. 21, 2006

(54) Image processing apparatus

(75) Inventor: Sunao Tabata, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/081,023

(22) Filed: Mar. 16, 2005

(51) Int. Cl. G06K 9/00

(52) U.S. Cl. 358/3.28; 382/100

(57) ABSTRACT

An image processing apparatus includes a scanner that inputs image data on an original, a reduction process section that reduces image data input by the scanner, a memory that stores and combines image data that are reduced by the reduction process section, a blank-sheet detection section that detects whether the image data that is input by the scanner is a blank sheet or not, a watermark process section that draws a watermark on the image data stored in the memory or the combined image data, using a detection result of the blank-sheet detection section, a printer that prints image data on which the watermark is drawn by the watermark process section, and a control circuit that executes an overall control.

### BACKGROUND OF THE INVENTION

1. Field of the Invention

The present invention relates to an image processing apparatus that processes an image using a watermark technique.

2. Description of the Related Art

In recent years, encryption techniques and electronic watermark techniques have been used in various fields because of the importance of data management. This similarly applies to a system having a completely digital architecture and to a system including both a digital architecture and an analog architecture, such as a digital copying machine.

Documents 1 to 5, for instance, describe electronic watermark techniques and the functions of digital copying machines:

Document 1: Jpn. Pat. Appln. KOKAI Publication No. 2003-134327,

Document 2: Jpn. Pat. Appln. KOKAI Publication No. 2000-216987,

Document 3: Jpn. Pat. Appln. KOKAI Publication No. H3-233578,

Document 4: Jpn. Pat. Appln. KOKAI Publication No. 2004-88201, and

Document 5: Jpn. Pat. Appln. KOKAI Publication No. 2001-77980.

Document 1 discloses a technique wherein watermark detection is executed for data that is read by a scanner. Depending on the presence/absence of a watermark, information about a watermark detection result is given, or a watermark is removed in combination with user authentication, etc.

Document 2 discloses a technique wherein in order to execute printing by a printer with a watermark overlaid, for example, a PDL for a watermark is created by a printer driver, and a normal image and the watermark PDL are interpreted on the printer side. Thus, image data with an overlaid watermark is formed.

Document 3 discloses a technique for providing a function of printing images of a plurality of pages on a single sheet in a copier, which is generally called “Nin1”.

Document 4 discloses a technique wherein an individual image process is executed on each of pages on an Nin1 image.

Document 5 discloses a technique wherein a carriage control, which is scanning means in a scanner, is associated with only a specific magnification, and other sub-scan magnifications are generated by signal processing.

As regards watermark techniques, as disclosed in Documents 1 and 2, a method of overlay on print and a function using the related information are proposed. In these examples, a difficult-to-perceive watermark, which is called an invisible watermark, is used. However, watermark pattern information, which is intentionally made perceptible and is called a visible watermark, may be laid on an original image and printed out.

On the other hand, the functions of a copying machine and a printer also include the function of printing a plurality of input images on a single paper sheet, which is called “Nin1”, as disclosed in Documents 3 and 4. In the actual copier, an output result of the same size as an input original is not merely obtained, but a function of enlargement/reduction printing is provided. The Nin1 function is one of new functions using the enlargement/reduction printing. However, an increase in cost would arise if data of all magnifications are routinely generated by an image input section. Thus, the technique of Document 5 is proposed.

As disclosed in Documents 1 and 2, the functions using the watermark printing and the watermark technique have been proposed. However, in the case where various input/output patterns, as in Documents 3 to 5, are combined with watermark techniques, it is not clear how to apply the watermark technique and to read the watermark.

As discussed above, even if the individual functions are independently provided, there is difficulty in actually using the respective functions in combination.

### BRIEF SUMMARY OF THE INVENTION

The object of an aspect of the present invention is to provide an image processing apparatus that effectively uses a watermark technique even in an environment in which various inputs/outputs are executed.

According to an aspect of the present invention, there is provided an image processing apparatus comprising: image input means for inputting an image on an original; magnification varying means for varying a magnification of image data that is input by the image input means; watermark process means for drawing a watermark on image data that is subjected to magnification variation by the magnification varying means; and image output means for outputting image data on which the watermark is drawn by the watermark process means.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram that schematically shows the structure of a digital copying machine according to a first embodiment, which relates to an image processing apparatus of the present invention;

FIG. 2 shows an example of the structure of a blank-sheet detection section in the first embodiment;

FIG. 3 shows an example of the structure of a watermark process section in the first embodiment;

FIG. 4A shows an example of a table that is used in a coordinate calculation section;

FIG. 4B shows an example of a table that is used in the coordinate calculation section;

FIG. 5A shows an example of the operation;

FIG. 5B shows an example of the operation;

FIG. 5C shows an example of the operation;

FIG. 5D shows an example of the operation;

FIG. 5E shows an example of the operation;

FIG. 5F shows an example of the operation;

FIG. 5G shows an example of the operation;

FIG. 5H shows an example of the operation;

FIG. 5I shows an example of the operation;

FIG. 6 shows an example of information to be inserted;

FIG. 7 is a block diagram that shows a modification of the first embodiment;

FIG. 8 is a block diagram that schematically shows the structure of a digital copying machine according to a second embodiment;

FIG. 9 schematically shows the structure of a scanner;

FIG. 10 shows examples of the shape of image data of the scanner;

FIG. 11 shows the structure of a watermark detection section;

FIG. 12 shows an example of a watermark pattern at a time of 25% input, which is input to the watermark detection section;

FIG. 13 shows an example of the structure of a watermark process section;

FIG. 14 is a block diagram that shows a modification of the second embodiment;

FIG. 15A schematically shows the structure of an ADF;

FIG. 15B schematically shows the structure of the ADF;

FIG. 15C schematically shows the structure of a printer;

FIG. 16 illustrates an input/output relationship of paper in the scanner and printer;

FIG. 17 shows an example of the structure of a watermark process section;

FIG. 18 is a view for explaining images with varied output magnifications, a main scan instruction, and a sub-scan instruction;

FIG. 19 shows an example of a structure in which a watermark process section is added to an apparatus having both a copying function and a printer function;

FIG. 20 is a view for explaining a watermark drawing area for enlargement input;

FIG. 21 is a block diagram that schematically shows the structure of a digital copying machine according to a third embodiment; and

FIG. 22 shows an example of the structure of a discrimination section.

### DETAILED DESCRIPTION OF THE INVENTION

Embodiments of the present invention will now be described with reference to the accompanying drawings.

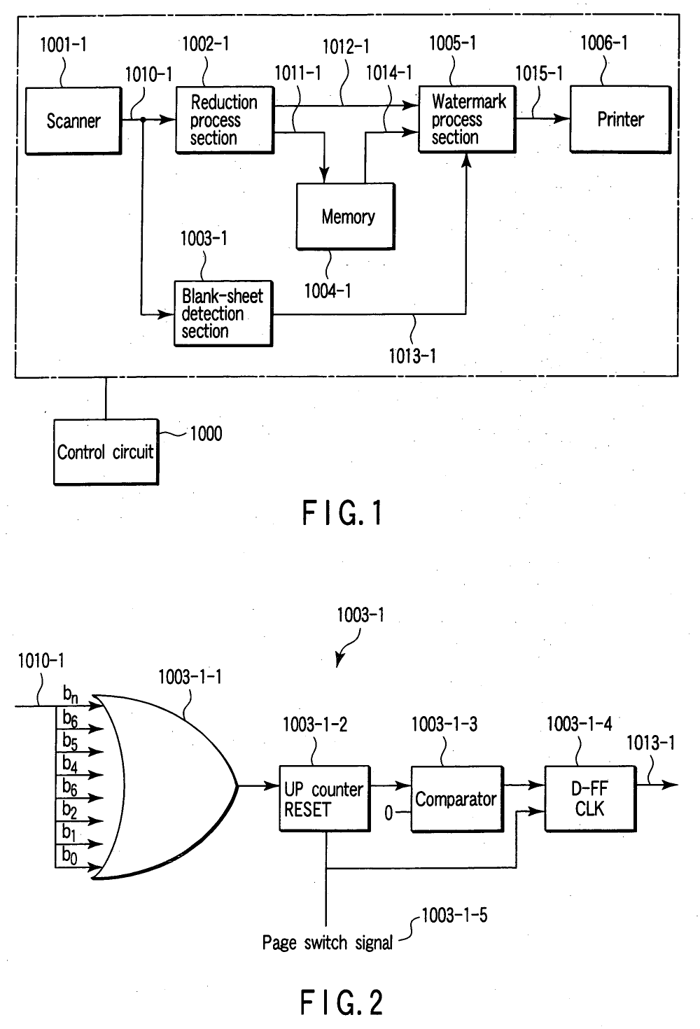

FIG. 1 schematically shows the structure of a digital copying machine according to a first embodiment, which relates to an image processing apparatus of the present invention.

The digital copying machine according to the first embodiment comprises a control circuit 1000, a scanner 1001-1, a reduction process section 1002-1, a blank-sheet detection section 1003-1, a memory 1004-1, a watermark process section 1005-1, and a printer 1006-1.

The control circuit 1000 executes an overall control of the digital copying machine.

The scanner 1001-1 inputs image data of an original.

The reduction process section 1002-1 reduces input image data.

The blank-sheet detection section 1003-1 detects whether the original is a blank sheet or not.

The memory 1004-1 stores and combines a plurality of reduced image data.

The watermark process section 1005-1 draws a watermark on non-reduced image data or combined image data.

The printer 1006-1 prints an image on which a watermark is drawn.

The structural components, other than the blank-sheet detection section 1003-1 and watermark process section 1005-1, are those of a conventional digital copying machine, so a description thereof is omitted.

FIG. 2 schematically shows the structure of the blank-sheet detection section 1003-1. As is shown in FIG. 2, in the blank-sheet detection section 1003-1, an OR circuit 1003-1-1 performs an OR operation of an input signal 1010-1. If a non-0 output is produced, an UP counter 1003-1-2 executes a count-up. The value of the UP counter 1003-1-2 is compared with “0” in a comparator 1003-1-3, and a comparison result is held in a D-FF 1003-1-4 on a page-by-page basis by a page switch signal 1003-1-5.

Specifically, if the value of the counter 1003-1-2 is “0” after the end of scan of 1 page, the comparator 1003-1-3 outputs “1” as a blank-sheet detection signal 1013-1. If this value is “non-0”, the comparator 1003-1-3 outputs “0” as a blank-sheet detection signal 1013-1.

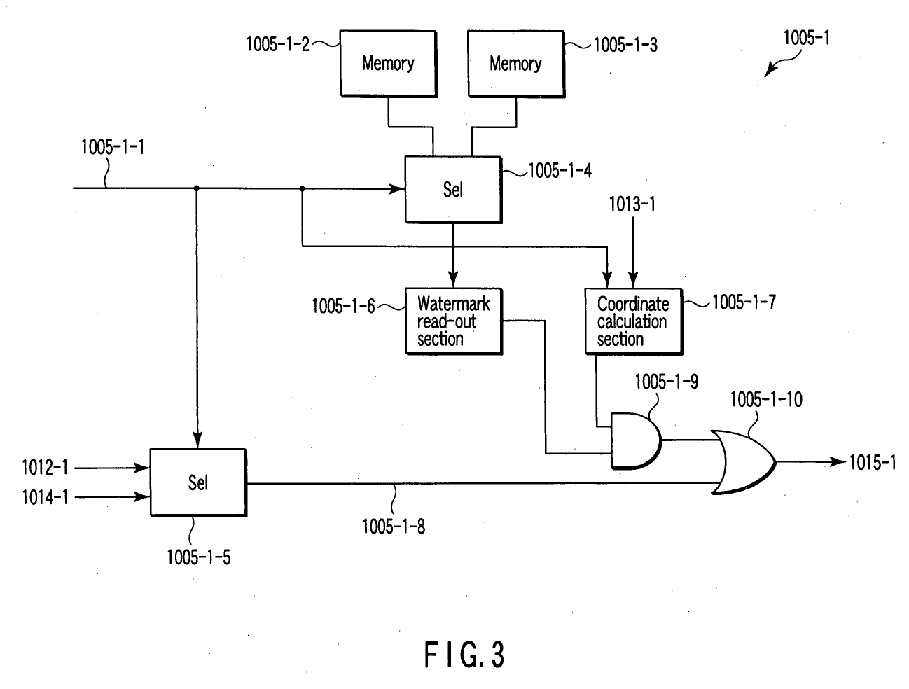

FIG. 3 schematically shows the structure of the watermark process section 1005-1 that is a characteristic point of the invention.

The watermark process section 1005-1 first receives a mode signal 1005-I-1 that instructs an Nin1 output mode or a 1-page output mode. In accordance with the mode signal 1005-1-1, a selector 1005-1-4 selects a memory 1005-1-2 for a watermark for 1 page or a memory 1005-1-3 for a watermark for Nin1.

Subsequently, a watermark read-out section 1005-1-6 reads out a watermark pattern from the 1-page watermark memory 1005-1-2 or Nin1 watermark memory 1005-1-3, which is selected by the selector 1005-1-4. The watermark pattern, which is read out by the watermark read-out section 1005-1-6, is output to an AND circuit 1005-1-9. On the other hand, a coordinate calculation section 1005-1-7 calculates coordinates on the basis of the mode signal 1005-1-1 and the blank-sheet detection signal 1013-1 from the blank-sheet detection section 1003-1, and outputs a calculation result to the AND circuit 1005-1-9.

The AND circuit 1005-1-9 executes an AND operation on the basis of the watermark pattern and the coordinate region, and outputs an operation result to an OR circuit 1005-1-10.

One of input 1-page image data 1012-1 and Nin1 image data 1014-1 is selected by a selector 1005-1-5 and delivered as input image data 1005-1-8 to the OR circuit 1005-1-10.

The OR circuit 1005-1-10 executes an OR operation on the basis of the output from the AND circuit 1005-1-9 and the input image data 1005-1-8, and outputs image data 1015-1 to the printer 1006-1.

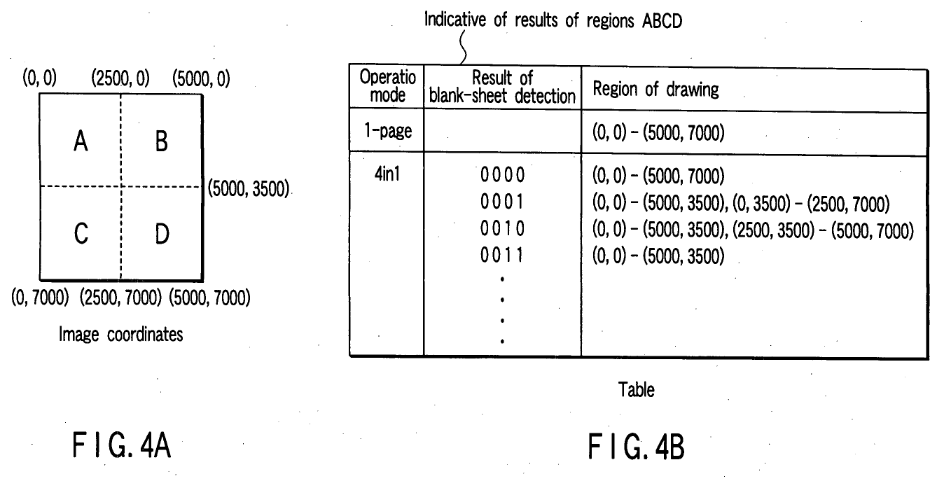

FIGS. 4A and 4B show examples of tables that are used in the coordinate calculation section 1005-1-7. Specifically, based on the tables shown, the coordinate calculation section 1005-1-7 sets a region for drawing. In the 1-page print mode, a blank-sheet detection result is not used. The reason for this is that in this embodiment, the memory 1004-1 is not used in the 1-page print mode, and thus the blank-sheet determination is not finished prior to the start of printing.

When coordinates shown in FIG. 4A are set, regions for drawing, as shown in FIG. 4B, are set in accordance with a blank-sheet determination result in the 4in1 mode.

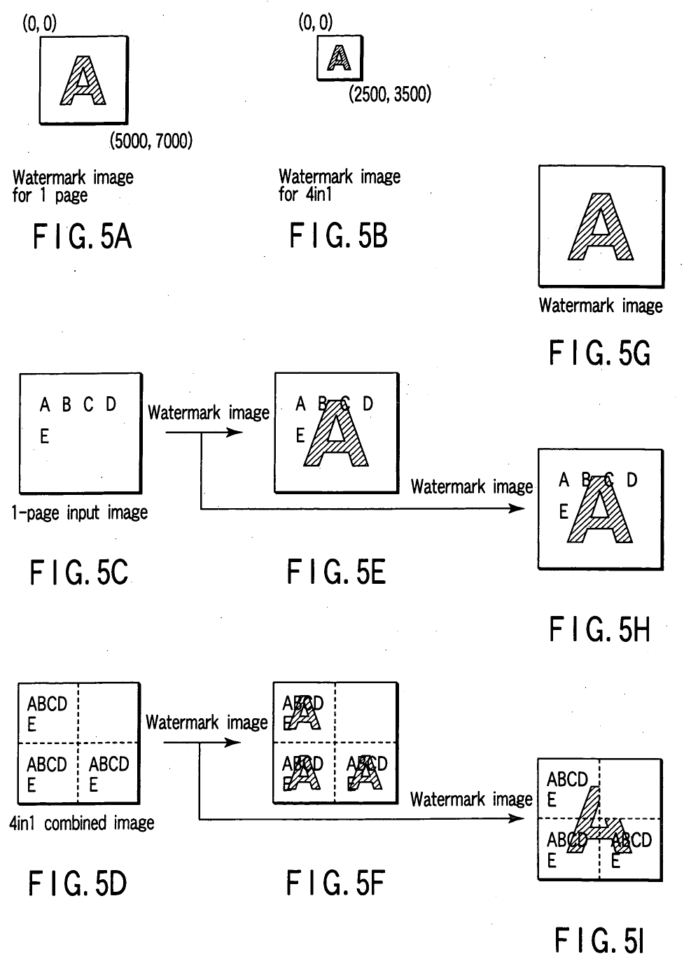

FIGS. 5A, 5B, 5C, 5D, 5E, 5F, 5G, 5H and 5I show examples of operations. As shown in FIG. 5A and FIG. 5B, different watermarks are prepared, depending on whether image data is composed of 1 page or a plurality of pages. In this case, watermark image data is drawn, as shown in FIG. 5F, on an Nin1 image including a blank page as shown in FIG. 5D. Thereby, compared to the case shown in FIG. 5E in which a watermark is drawn on the entire page, the feeling of interference is reduced.

In the case where the same watermark is drawn on a 1-page image and an Nin1 image, a watermark image as shown in FIG. 5G is drawn. As a result, images shown in FIGS. 5H and 5I are obtained, respectively. In the case of an image including a plurality of pages, no watermark is drawn on a blank page and the feeling of interference is reduced.

In this embodiment, a visible watermark is drawn. Even in the case where an invisible watermark is drawn (e.g. a difficult-to-perceive yellow watermark is drawn), the feeling of interference is similarly given, though the watermark is difficult to perceive.

In the case of drawing a watermark on an image region using a frequency, etc., if a definite blank region is understood, consideration can be given to a watermark on the region. Therefore, the operability for watermark drawing can be enhanced.

In this embodiment, the watermark process is switched on the basis of the presence/absence of a blank region. Alternatively, a color page and a monochromatic page may be discriminated, and the watermark process may be switched depending on whether an Nin1 image includes a color page and a monochromatic page, or an Nin1 image consists of only monochromatic pages. Compared to the case in which the selection of the watermark is executed on the basis of page-by-page color/monochromatic discrimination, the information of “color” can positively be used. Therefore, the convenience is enhanced. The characteristic thereof should not be limited to this.

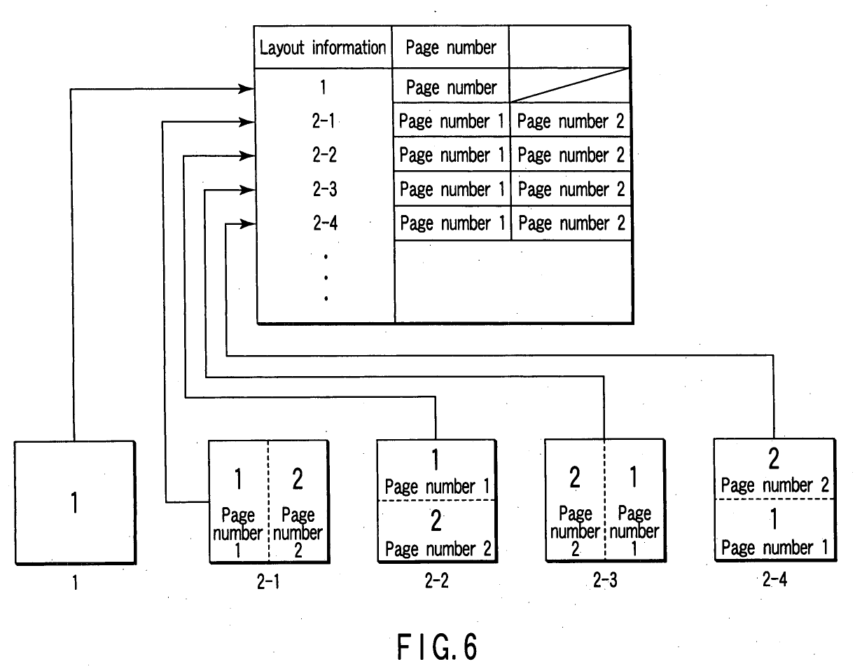

FIG. 6 shows an example of information to be inserted. As shown in the Figure, 1-page print and Nin1 print are discriminated. In the case of Nin1, the associated layout information and page information is inserted. Thereby, the convenience of a watermark-drawn image is enhanced. In the case of 1 page, only the information indicative of 1 page and the page number are used. For example, in the case of 2in1, different information items, i.e. 2in1 layout information and each page number, are added.

As has been described above, according to the first embodiment, the watermark drawing method and information are altered between 1-page print and Nin1 print. Thereby, the convenience of watermark drawing can be enhanced. In this example, since Nin1 is adopted, the reduction process is executed. The present embodiment is similarly applicable to a single reduced/enlarged image, although the number of images is one in this case. For example, if an enlargement ratio is inserted in the information, the convenience of watermark information is further enhanced.

Next, a modification of the first embodiment is described.

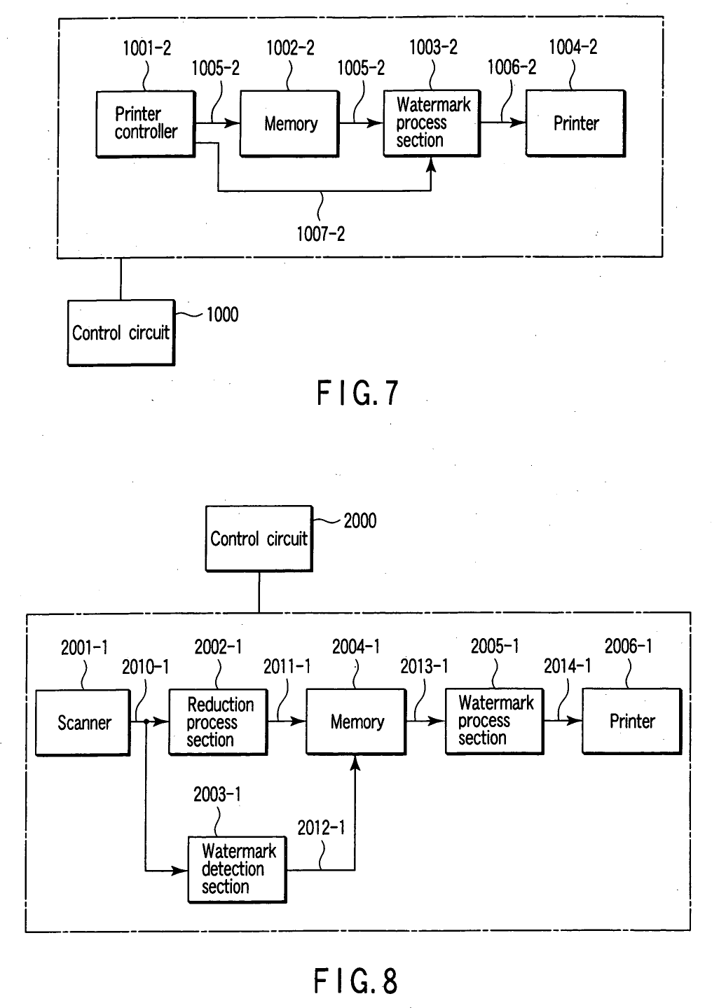

FIG. 7 shows a modification of the first embodiment. The image processing apparatus of this modification comprises a printer controller 1001-2, a memory 1002-2, a watermark process section 1003-2 and a printer 1004-2. This modification is substantially the same as the first embodiment, except that the functions of the scanner 1001-1, reduction process section 1002-1 and blank-sheet detection section 1003-1 in the first embodiment are replaced with the printer controller 1001-2.

To start with, the printer controller 1001-2 develops 1-page image data or Nin1 image data 1005-2 in the memory 1002-2. Further, the printer controller 1001-2 outputs a blank-sheet detection result 1007-2 to the watermark process section 1003-2.

The watermark process section 1003-2 draws a watermark on the 1-page image data or Nin1 image data 1005-2 from the memory 1002-2, using the blank-sheet detection result 1007-2 and 1-page watermark image data or Nin1 watermark image data (not shown). Thus, the watermark process section 1003-2 generates image data 1006-2 on which the watermark is drawn, and outputs it to the printer 1004-2.

The printer 1004-2 effects printing on the basis of the input image data 1006-2.

In general, the printer controller 1001-2 interprets a PDL (page-description language) and generates a bitmap. When Nin1 image data is to be generated, the printer controller 1001-2 receives an instruction from a driver (not shown) or the like, and generates a reduced image from the beginning and generates a bitmap with an instructed Nin1 layout. Since the data is written in the page-description language, it is easy to generate and output the information 1007-2 that represents the presence/absence of a blank page.

In this example, the watermark image is drawn on the generated bitmap image data by the watermark process section 1003-2. Alternatively, the printer controller 1001-2 may be provided with this function.

As has been described above, according to the modification of the first embodiment, different watermarks can be drawn between 1-page image data and Nin1 image data even with respect to the data that is output from the printer controller. Therefore, the convenience of watermark drawing can be enhanced.

Next, a second embodiment is described.

FIG. 8 schematically shows the structure of a digital copying machine according to the second embodiment.

Specifically, the digital copying machine of the second embodiment comprises a control circuit 2000, a scanner 2001-1, a reduction process section 2002-1, a watermark detection section 2003-1, a memory 2004-1, a watermark process section 2005-1, and a printer 2006-1.

The control circuit 2000 executes an overall control of the digital copying machine.

The scanner 2001-1 scans an original and outputs image data 2010-1.

The reduction process section 2002-1 reduces the image data 2010-1 from the scanner 2001-1.

The watermark detection section 2003-1 detects a watermark from the input image data 2010-1.

The memory 2004-1 stores the reduced image data or non-reduced image data 2011-1.

The watermark process section 2005-1 subjects image data 2013-1, which is read out from the memory 2004-1, to a watermark process, thereby generating image data 2014-1.

The printer 2006-1 effects printing on the basis of the watermark-drawn image data 2014-1.

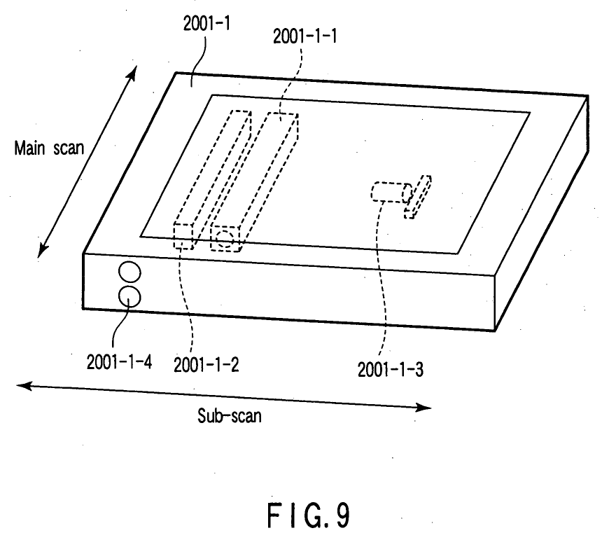

FIG. 9 schematically shows the structure of the scanner 2001-1. As is shown in the Figure, the scanner 2001-1 is a conventional one, which is generally called a line-scan type scanner.

The scanner 2001-1 comprises a lamp & mirror unit 2001-1-1 that illuminates an original; a second mirror unit 2001-1-2 that guides reflective light from the illuminated original into a lens unit 2001-1-3; and a motor 2001-1-4 that scans the lamp & mirror unit 2001-1-1 and second mirror unit 2001-1-2 over the original table in a sub-scan direction. The scanner 2001-1 is controlled by a control signal (not shown).

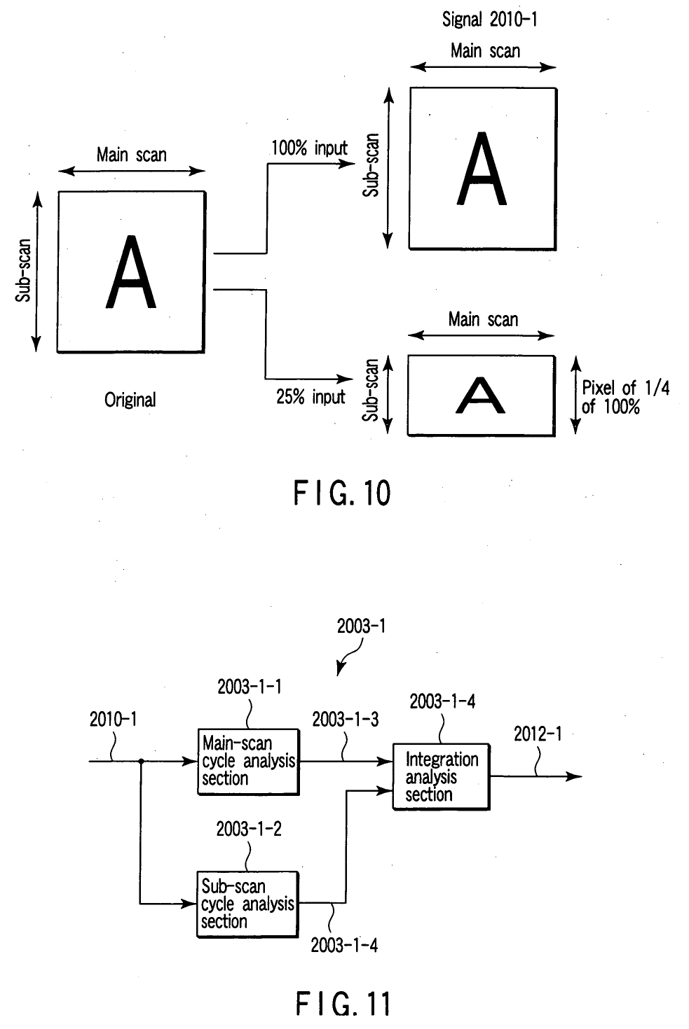

In general, because of the structure of the mechanism of the above-described type of scanner 2001-1, image data 2010-1 that is obtained by a magnification-varying process has shapes as shown in FIG. 10. In the main scan direction, the magnification of the image is 100% regardless of a magnification-varying instruction. On the other hand, in the sub-scan direction, scanning is executed by varying the speed for mechanically scanning a sensor (not shown). Thus, image data that is reduced from the beginning is digitally generated. For example, in the case where the sub-scan is 25% while the main-scan is 100%, a pixel of ¼ of 100% is obtained.

FIG. 11 shows the structure of the watermark detection section 2003-1. In the watermark detection section 2003-1, a main-scan cycle analysis section 2003-1-1 produces a main-scan analysis result 2003-1-3 and a sub-scan cycle analysis section 2003-1-2 produces a sub-scan analysis result 2003-1-4 with respect to the input image data 2010-1. An integration analysis section 2003-1-4 integrally analyzes the main-scan analysis result 2003-1-3 and sub-scan analysis result 2003-1-4, and outputs an analysis result 2012-1.

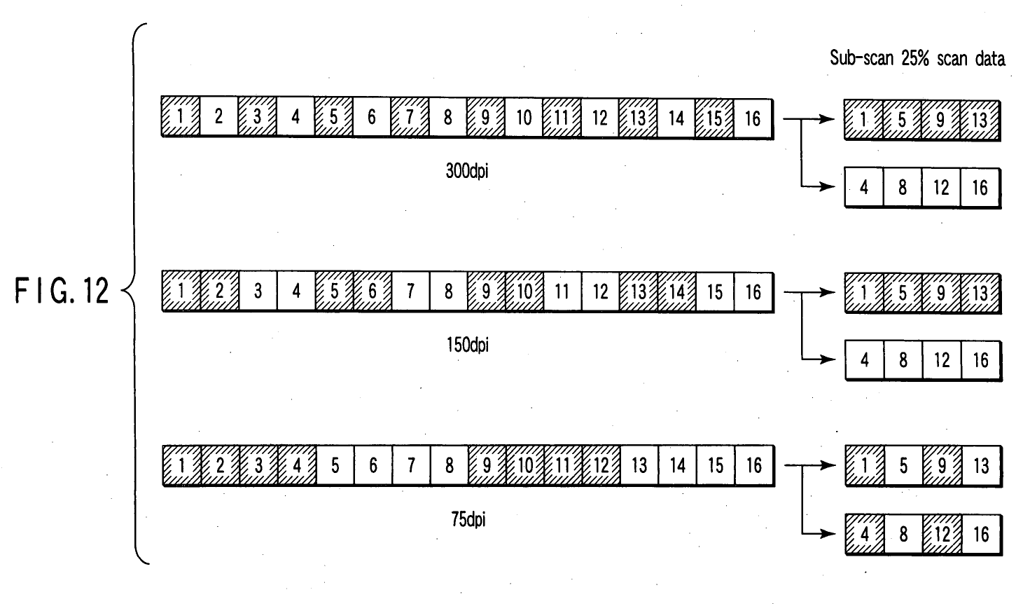

FIG. 12 shows states of pixels with information in a case where an image, which is formed by drawing a watermark with a characteristic amount at a given frequency on the output image data 2013-1 in the watermark process section 2005-1, is scanned by 25% by the scanner 2001-1.

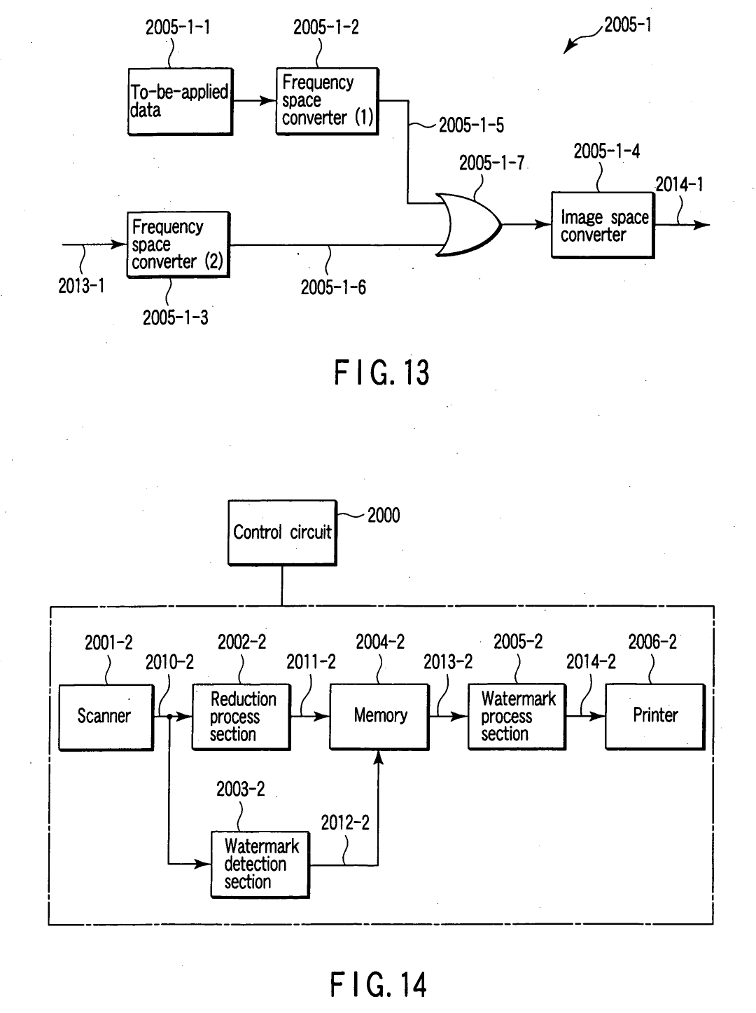

The watermark process section 2005-1 applies watermark information by imparting a characteristic amount to a given frequency space, as shown in FIG. 13. Specifically, a frequency space converter (2) 2005-1-3 converts the image data 2013-1 to a frequency space signal 2005-1-6. Similarly, a frequency space converter (1) 2005-1-2 converts to-be-applied data 2005-1-1 to a to-be-applied frequency space as watermark frequency data 2005-1-5. An OR circuit 2005-1-7 adds the watermark frequency data 2005-1-5 and frequency space signal 2005-1-6 with the frequency space, and an image space converter 2005-1-4 converts the added result to an actual image 2014-1.

If the printer 2006-1 has a performance of 600 dpi, the watermark process section 2005-1 can receive watermark data with a cycle of 300 dpi or less.

In the examples of FIG. 12, characteristic amounts are applied to 300 dpi, 150 dpi and 75 dpi. If the scanner 2001-1 has a performance of 600 dpi, the watermark detection section 2003-1 can detect the characteristic amounts of the respective cycles at the time of 100% input.

However, in the sub-scan direction at the time of reduction input, as shown in the scanned data shown in FIG. 12, detection is successfully done or fails depending on cases, except for the case of 75 dpi. The upper and lower parts of the scanned data in FIG. 12 indicate a difference in scan start position. It is not ensured that the actually output data is precisely scanned from the left-end start point. Thus, at the time of the reduction process, a watermark image using a relatively low cycle is applied (in this example, 75 dpi in order to match with 25% scanning). Thereby, it is possible to provide a watermark image, which is capable of watermark detection even in the case of alteration of magnification of an image.

In the present example, the reduction input is described. However, the same applies to the enlargement input. Obviously, at a time of 400% input, if a longer cycle than a size of ⅛ of an image is used, detection is not enabled.

As regards the information that is inserted as a watermark, the inputtable information is limited if only low-frequency information is used. Thus, basic information, such as document copy prohibition/permission, is input in low-frequency information, and information that requires a greater information amount, such as document numbers, is input in high-frequency information. Thereby, the convenience of a watermark can be enhanced.

In this example, the watermark detection section 2003-1 generates a copy prohibition/permission signal 2012-1. If copy is prohibited, the content of the memory 2004-1 is cleared.

In the scanner 2001-1, as described in prior-art Document 5, scanning is not executed in all the range of sub-scan magnifications of 100% to 25% (in this example). For instance, scanning is executed only at 100% and 50%. As regards the other magnifications, a magnification-altered image may be obtained by altering the magnification not only in the main scan direction but also in the sub-scan direction in the reduction process section 2002-1. In this case, if a watermark is applied by the watermark process section 2005-1 using a cycle with consideration to the magnification, the input cycle can effectively be selectively used in consideration of the characteristics of scanning.

In this example, all magnifications from 25% to 100% can be checked. Alternatively, the cycle to be used may be determined mainly in consideration of a specific sheet size magnification such as size reduction from A3 to A4 (71%).

Next, a modification of the second embodiment is described.

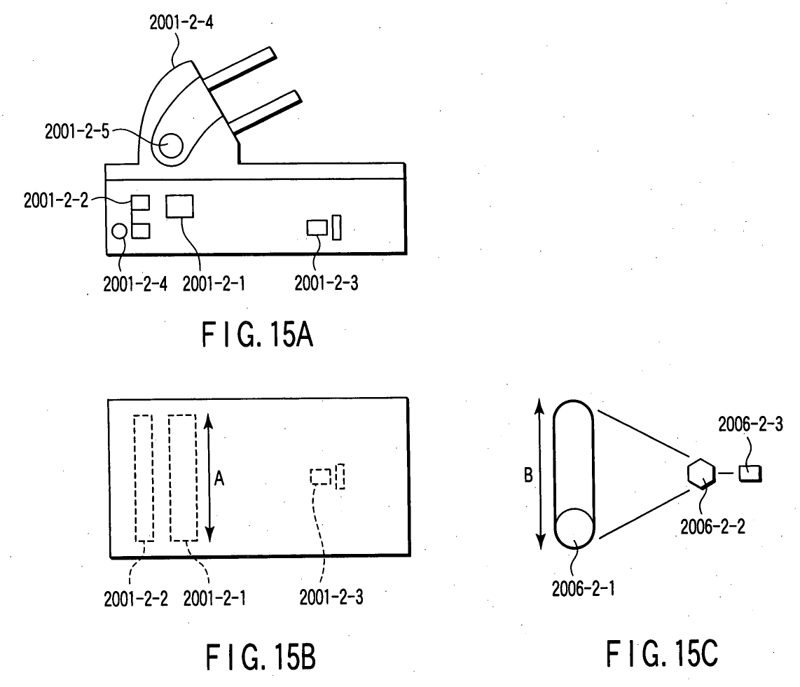

FIG. 14 shows a modification of the second embodiment. In a digital copying machine according to the modification of the second embodiment, a scanner 2001-2 is basically configured, as shown in FIGS. 15A and 15B, and a printer 2006-2 has a structure shown in FIG. 15C. Specifically, the scanner 2001-2 and printer 2006-2 have substantially the same scan width, and a watermark detection section 2003-2 and a watermark process section 2005-2 are slightly different from those of the second embodiment. In the other respects, this modification is the same as the second embodiment.

In FIG. 15A, reference numeral 2001-2-4 denotes a device that is called an ADF (Auto Document Feeder). Originals are successively fed in, and reflective light from the original is input to a lens unit 2001-2-3 via a stationary lamp & mirror unit 2001-2-1 and second mirror unit 2001-2-2. The ADF 2001-2-4 can input a great number of originals.

FIG. 15C shows a part of the printer 2006-2, which includes a laser beam emitter 2006-2-3, and a polygon 2006-2-2 that applies a laser beam over a drum 2006-2-1. FIG. 15B is a top view of the scanner shown in FIG. 15A. In general, in a digital copying machine, the length A in the main scan direction of the lamp & mirror unit 2002-1-1 is substantially equal to the length B of the drum 2006-2-1 shown in FIG. 15C.

Taking this relationship into account, as much as possible image data is input in the main scan that enables electrical scan, compared to the sub-scan that is set by the physical speed in both input and output. Thereby, the input/output relationship is maintained, and the productivity in copying performance is enhanced.

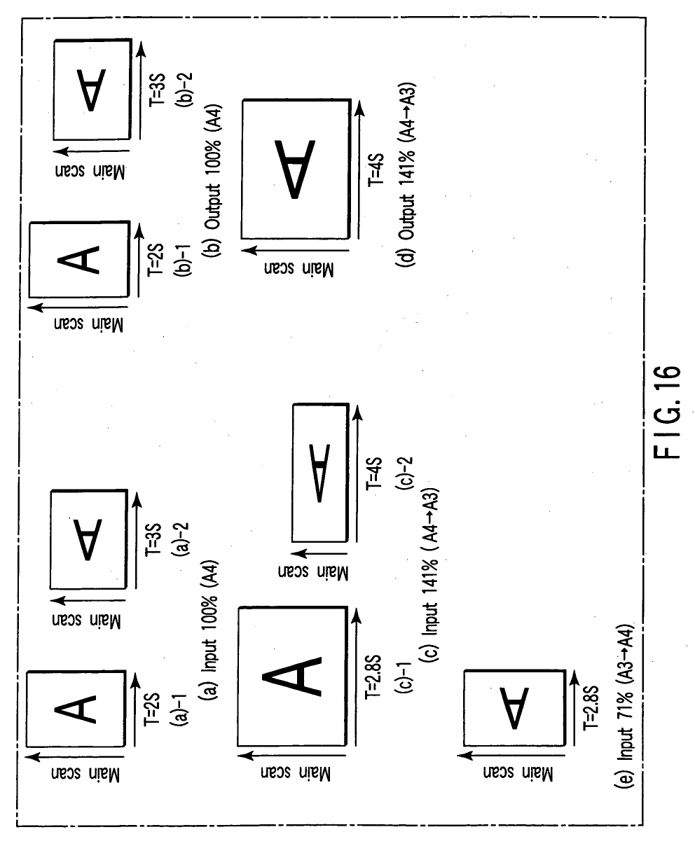

FIG. 16 illustrates this example.

For instance, as regards the input/output of A4 size, a high speed is obtained with a combination of (a)-1 and (b)-1. As regards the printing of A4 size with an input of A3 size (reduction), a high speed is obtained with (e) and (b)-1. As regards the printing of A3 size with an input of A4 size (enlargement), a high speed is obtained with (c)-1 and (d) ((d) and (e) are one kind because of physical limitation). In general, in order to secure the productivity, the user is recommended to choose the input/output of the above patterns.

Depending on the presence/absence of paper, (b)-2 may possibly be selected for the output. In this case, if the input of (a)-1 is selected when the print result is copied, the productivity is enhanced.

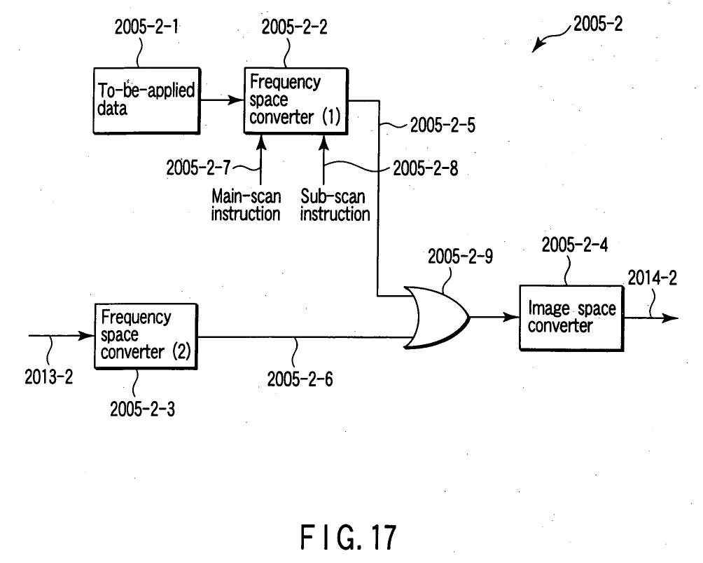

FIG. 17 shows the watermark process section 2005-2, which is configured in consideration of the above.

This configuration differs from that of the second embodiment with respect to a frequency space converter (1) 2005-2-2 and generated frequency data 2005-2-5 for a watermark, and a main-scan instruction 2005-2-7 and a sub-scan instruction 2005-2-8 are added. In other respects, the configuration is the same as that of the second embodiment.

As has been mentioned in connection with the second embodiment, the frequency that can be detected by the magnification alteration is limited in the sub-scan direction, but the main scan can be executed with the resolution of the apparatus. Ideally, it is safe to adopt a method in which the same result is obtained by analysis in main scan or sub-scan. In general, however, there are limitations due to the structure of the digital copying machine shown in FIG. 16. It is thus possible to adopt such a configuration that a pattern using many frequencies in a scan direction, which probably becomes a main-scan direction, is input in the scanner 2001-2, and the watermark detection section 2003-2 selectively handles information that is detected in the main/sub-scan. Thereby, the convenience of a watermark image can be enhanced.

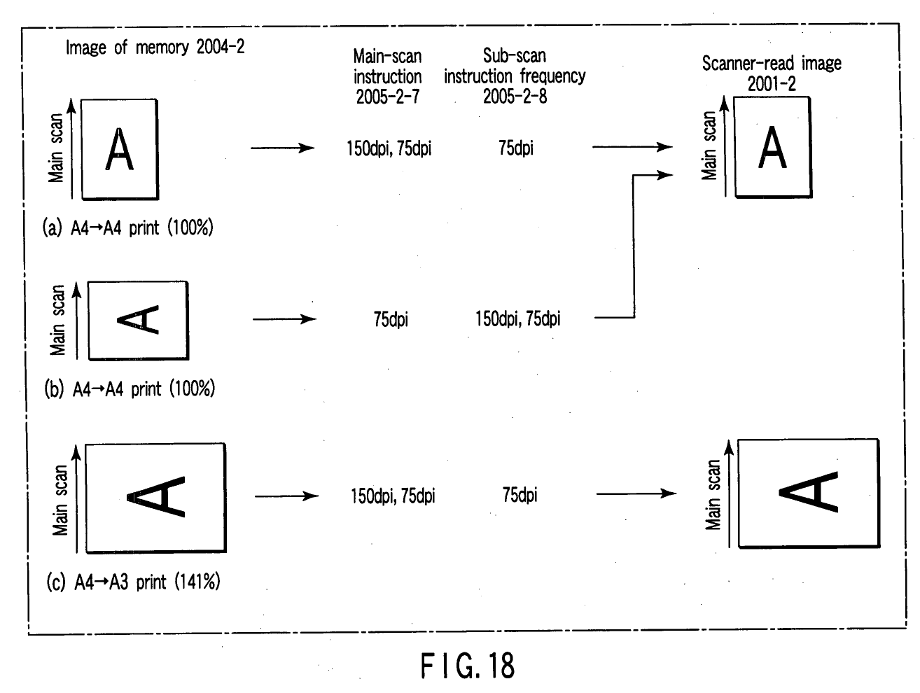

Specifically, with patterns (a), (b) and (c) shown in FIG. 18, the amount of information of one of frequencies is increased by the main-scan instruction 2005-2-7 and sub-scan instruction 2005-2-8. Thereby, a greater amount of information than at the time of magnification alteration can be used, and the convenience of a watermark image is enhanced.

It is assumed that the memory 2004-2 stores an image that has been subjected to magnification alteration or rotation.

As has been described above, according to the modification of the second embodiment, a watermark-inserted image is obtained in consideration of the characteristics at the time of magnification alteration in the input/output apparatus, and the convenience of a watermark can be enhanced.

In this example, for the purpose of description, the digital copying machine including the input/output apparatus is exemplified. With the configuration of the printer controller according to the modification of the first embodiment, the watermark may similarly be applied in consideration of the manner of use of the watermark. Thereby, even with the watermark in the printer output, the convenience can similarly be enhanced.

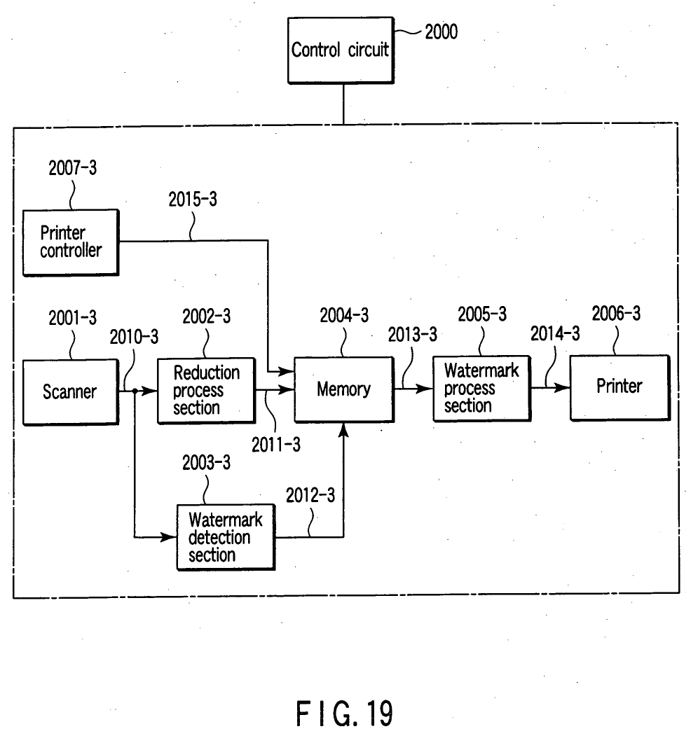

FIG. 19 shows an apparatus having both the copying function and the printer function. If this apparatus is configured to commonly input a watermark, the convenience is further enhanced.

This apparatus is similar to the modification of the second embodiment, except that image data from a scanner 2001-3 and image data from a printer controller 2007-3 are input to a memory 2004-3.

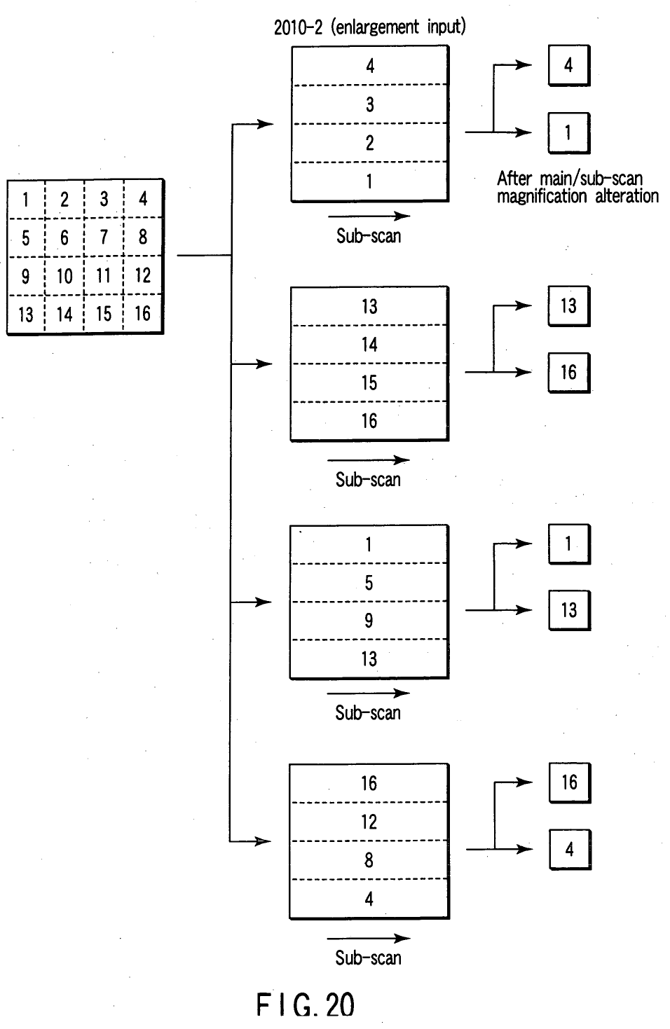

In this example, the reduction process is exemplified. However, as shown in FIG. 20, in accordance with an enlargement process, watermark information may exactly be input in a region of ¼ from the four corners (in a case of a scanner input up to 400% enlargement). Thereby, it is possible to obtain an image to which a watermark is applied in consideration of the enlargement process, too.

If a paper sheet is placed on the original table, watermark information can be read from any one of the four-corner regions shown in FIG. 20, although this depends on the direction of placement of the original and the reference position of the scanner. If the positions on the four sides (1, 2, 3, 4, 5, 8, 9, 12, 13, 14, 15 and 16 in FIG. 20) are used, the convenience is further enhanced.

Next, a third embodiment is described.

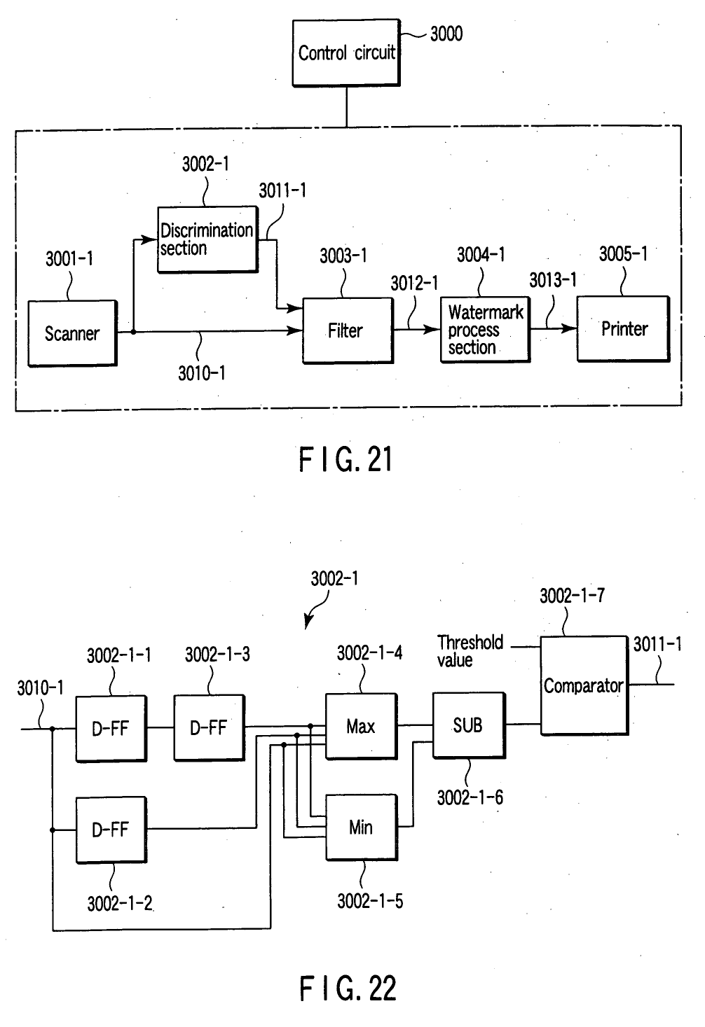

FIG. 21 schematically shows the structure of a digital copying machine according to the third embodiment.

The digital copying machine of the third embodiment comprises a control circuit 3000, a scanner 3001-1, a discrimination section 3002-1, a filter 3003-1, a watermark process section 3004-1, and a printer 3005-1.

The discrimination section 3002-1 executes a character/photo discrimination process on the basis of input image data from the scanner 3001-1. The filter 3003-1 executes adaptive filtering of image. data 3010-1, using a discrimination result 3011-1. The watermark process section 3004-1 draws a watermark on filtered image data 3012-1. The printer 3005-1 executes printing on the basis of watermark-drawn image data 3013-1.

Each of these processes is a conventional technique. FIG. 22 shows an example of the structure of the discrimination section 3002-1. The discrimination section 3002-1 calculates the magnitude of variation of a value around a pixel to be processed. If the magnitude is greater than a threshold, an output indicative of a character (=1) is produced. If the magnitude is less than the threshold, an output indicative of a photo (=0) is produced.

On the other hand, if the watermark is a visible one, an image pattern shown in FIG. 5 is drawn. If the watermark is an invisible one, a high-frequency pattern as shown in FIG. 12 is drawn. However, it is obvious that if the discrimination process is executed after the watermark is drawn, information relating to the watermark is detected in addition of the characteristic of the image proper. In this embodiment, in order to cope with this problem, the discrimination section 3002-1 is disposed in front of the watermark process section 3004-1. Thereby, an output image can be corrected with high precision and a watermark is drawn. Therefore, a high-quality watermark image can be obtained.

The invisible watermark, compared to the image, is basically formed by applying higher-frequency data, as illustrated in FIG. 12. However, a higher-quality watermark image can be formed if no watermark is inserted in a character region or a watermark different from a watermark on a non-character region is inserted, using the discrimination 3011-1. For example, if a watermark that deforms a given character is input to the character region, the precision of the watermark is improved. As regards the visible watermark, if the method of inserting the watermark is similarly changed, a watermark image can be obtained without degrading the character quality.

In this example, the discrimination section is provided in front of the watermark process section 3004-1. However, if the watermark process section outputs a signal representative of a drawn watermark, the discrimination section 3002-1 can execute discrimination in consideration of the watermark region. Thereby, the degradation in discrimination of the watermark region can be reduced.

As has been described above, according to the embodiments of the invention, the watermark is drawn in consideration of the characteristics of the image input/output apparatus. Thereby, watermark image data with high convenience can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
image input means for inputting an image on an original;
magnification varying means for varying a magnification of image data that is input by the image input means;
watermark process means for drawing a watermark on image data that is subjected to magnification variation by the magnification varying means; and
image output means for outputting image data on which the watermark is drawn by the watermark process means.

2. An image processing apparatus comprising:
image input means for inputting an image on an original;
reduction means for reducing image data that is input by the image input means;
image combining means for combining a plurality of image data, which are reduced by the reduction means, into single image data;
watermark process means for drawing a watermark on image data that is reduced by the reduction means, or image data that is combined by the image combining means; and
image output means for outputting image data on which the watermark is drawn by the watermark process means.

3. The image processing apparatus according to claim 2, wherein the watermark process means switches a region where the watermark is to be drawn, in accordance with the image data that is reduced by the reduction means.

4. The image processing apparatus according to claim 2, wherein the watermark process means switches information, which is applied as a watermark, depending on whether single image data is to be output or image data that comprises the combination of the plurality of image data is to be output.

5. An image processing apparatus comprising:
instruction means for instructing generation of reduced image data and instructing combining of the generated reduced image data;
bitmap generation means for generating a bitmap by interpreting image data that is described in an output description language, in accordance with an instruction from the instruction means;
watermark process means for drawing a watermark on image data of the bitmap that is generated by the bitmap generation means; and
image output means for outputting image data on which the watermark is drawn by the watermark process means.

6. An image processing apparatus comprising:
instruction means for instructing a scan condition and a magnification variation condition;
image input means for relatively moving an image on an original in a sub-scan direction and reading the image in accordance with the scan condition that is instructed by the instruction means;
magnification varying means for varying a magnification of image data, which is read by the image input means, to a desired magnification, in accordance with the magnification variation condition that is instructed by the instruction means;
information detection means for detecting information, which contains a frequency as a characteristic amount, from the image data that is read by the image input means;
information burying means for burying the information, which contains the frequency as the characteristic amount, in the image data that is subjected to the magnification variation by the magnification varying means; and
image output means for outputting image data in which the information is buried by the information burying means.

7. The image processing apparatus according to claim 6, wherein the information burying means determines a burying frequency in accordance with an upper limit and a lower limit of the scan condition that is instructed by the instruction means.

8. The image processing apparatus according to claim 6, wherein the information burying means determines a burying frequency in accordance with a number of scan points of the scan condition that is instructed by the instruction means.

9. An image processing apparatus comprising:
image input means for inputting an image;
information burying means for burying information, which contains a frequency as a characteristic amount and varies from frequency to frequency, in image data that is input by the image input means; and
image output means for outputting image data in which the information is buried by the information burying means.

10. The image processing apparatus according to claim 9, wherein the information burying means applies basic information to a low frequency.

11. An image processing apparatus comprising:
instruction means for instructing a scan condition and a magnification variation condition;
image input means for relatively moving an image on an original in a sub-scan direction and reading the image in accordance with the scan condition that is instructed by the instruction means;
magnification varying means for varying a magnification of image data, which is read by the image input means, to a desired magnification, in accordance with the magnification variation condition that is instructed by the instruction means;
information detection means for detecting information, which contains a frequency as a characteristic amount, from the image data that is read by the image input means;
information burying means for burying the information, which contains the frequency as the characteristic amount, in the image data, which is subjected to the magnification variation by the magnification varying means, separately in main scan and sub-scan; and
image output means for printing out image data, in which the information is buried by the information burying means, on paper.

12. The image processing apparatus according to claim 11, wherein the information burying means applies more information in one scan direction of an image than in another scan direction, the one scan direction being a direction in which a read speed of the original in the image input means takes a maximum value, and the one scan direction becoming a main scan direction of the image input means.

13. The image processing apparatus according to claim 11, wherein the information burying means applies basic information to a low frequency in a scan direction of an image that is a direction in which a read speed of the original in the image input means takes a maximum value, and that becomes a sub-scan direction of the image input means.

14. An image processing apparatus comprising:
bitmap generation means for generating a bitmap by interpreting image data that is described in an output description language;
information burying means for burying the information, which contains a frequency as a characteristic amount, in image data of the bitmap that is generated by the bitmap generation means, separately in a main scan direction and a sub-scan direction; and
image output means for printing out image data, in which the information is buried by the information burying means, on paper.

15. The image processing apparatus according to claim 14, wherein the information burying means applies more information in a direction than in another direction, in which a printable maximum-length range in a main scan direction of the image output means becomes greater.

16. The image processing apparatus according to claim 14, wherein the information burying means draws at least one watermark in an area of a predetermined range from each of corners of four regions of an image data region that is halved in a main scan direction and in a sub-scan direction.

17. An image processing apparatus comprising:
image input means for inputting an image on an original;
bitmap generation means for generating a bitmap by interpreting data, which is described in an output description language, in image data that is input by the image input means;
selection means for selecting one of the image data that is input by the image input means and image data of the bitmap that is generated by the bitmap generation means; and
watermark process means for drawing a watermark on the image data that is selected by the selection means.

18. An image processing apparatus comprising:
image input means for inputting an image on an original;
discrimination means for discriminating image data that is input by the image input means, and generating a discrimination signal;
image correction means for correcting the image data, which is input by the image input means, using the discrimination signal that is generated by the discrimination means;
watermark process means for drawing a watermark on image data that is corrected by the image correction means; and
image output means for outputting image data on which the watermark is drawn by the watermark process means.

19. The image processing apparatus according to claim 18, wherein the watermark process means executes a process in accordance with the discrimination signal that is generated by the discrimination means.

20. An image processing apparatus comprising:
image input means for inputting an image on an original;
watermark process means for drawing a watermark on image data that is input by the image input means, and outputting pixel-by-pixel information relating to presence/absence of burying of a watermark;
discrimination means for discriminating the image data that is input by the image input means, and generating a discrimination signal;
image correction means for correcting the image data, which is output from the watermark process means, using the discrimination signal that is generated by the discrimination means; and
image output means for outputting image data that is corrected by the image correction means.
